(19) United States
(12) Patent Application Publication
(10) Pub. No.: US 2007/0109107 A1
(43) Pub. Date: May 17, 2007

(54) Theft identification and deterrence system for an automobile

(76) Inventor: Tia M. Liston, St. Louis, MO (US)

Correspondence Address: HARSHAW RESEARCH INCORPORATED, P O BOX 418, OTTAWA, KS, 66067, US

(21) Appl. No.: 11/274,563

(22) Filed: Nov. 15, 2005

(51) Int. Cl. B60R 25/10; H04N 7/18

(52) U.S. Cl. 340/426.15; 340/426.18; 348/148

(57) ABSTRACT

A theft identification and deterrence system includes a camera mountable in the dashboard of an automobile and a sensor capable of sensing entry of a person into the automobile. The system includes a microcontroller for actuating the camera to capture images of the person who has entered the vehicle and a transmitter for sending the images to a remote viewing device such as a user's mobile phone viewing screen. The microcontroller includes programming that enables the user to remotely deactivate the system if, after reviewing the transmitted image, determines the access is authorized. Or, the user may call the police if access is unauthorized and the camera continues to take and store images of the potential thief.

### BACKGROUND OF THE INVENTION

The present invention relates generally to security systems and, more particularly to a theft identification and deterrence system for an automobile. The present system not only detects an attempted unauthorized entry into a vehicle, but provides notice to a vehicle owner and transmits a picture of the alleged thief to the owner and, selectively, to the police.

Auto theft continues to be a major problem in the United States. With a vehicle theft occurring approximately every 25 seconds in the U.S., only about 14% of those thefts result in an arrest. The high rate of vehicle theft results in inconvenience and danger to auto owners as well as to increased insurance premiums for all motorists.

Various devices and systems have been proposed in the art for detecting when a vehicle is being broken into. However, the frequency of false alarms with car alarms has lead to apathy and unconcern by people in proximity to the vehicle from which the alarm is sounding from. Other devices have been proposed that dial a person's cell phone or pager when their car's alarm has been activated. Although assumably effective for their intended purposes, the known systems and patent proposals are still subject to false alarms or require the vehicle owner to physically return to their vehicle to verify the authenticity of the alarm.

Therefore, it would be desirable to have a system that includes a camera to take and then transmit a picture of the potential thief to the vehicle owner's cell phone to provide the owner an opportunity to verify the authority (or lack of authority) of the person who has accessed the vehicle. Further, it would be desirable to have a system that enabled a vehicle user to selectively disarm the alarm system from a remote location if the access is authorized or to call the police if the access is unauthorized. Still further, it would be desirable to have a system that would continuously update either the user or police with pictures of the thief as a theft continues.

### SUMMARY OF THE INVENTION

A theft identification and deterrence system for an automobile according to the present invention includes a camera adapted to be mounted inside the automobile, such as on the dashboard, for capturing images. The system further includes a sensor capable of sensing a triggering event indicative of an entry or attempted entry of a person into the automobile. Further, a microcontroller is connected to the sensor and camera for actuating the camera to capture one or more images of the person who has entered the automobile upon sensing that entry.

The microcontroller is also connected to a transmitter for transmitting a captured image to a user viewing unit, such as a cell phone having a viewing screen. The microcontroller is in electrical communication with first and second switches such that a user is able to selectively activate or deactivate the system remotely. More particularly, the user is able to send a signal from his cell phone to the processor to deactivate the security system if the user determines that the person in the vehicle is authorized. This might be a situation where a friend or family member of the automobile owner is authorized to enter the vehicle. On the other hand, the owner may notify the police and allow the microcontroller to continue to collect images with the camera.

Therefore, a general object of this invention is to provide a theft identification and deterrence system.

Another object of this invention is to provide a system, as aforesaid, that senses when a potentially unauthorized person has entered a vehicle.

Still another object of this invention is to provide a system, as aforesaid, that includes a camera for capturing digital images of a person who has entered a vehicle.

Yet another object of this invention is to provide a system, as aforesaid, that may be deactivated by a user from a remote location if the access is deemed to be authorized.

A further object of this invention is to provide a system, as aforesaid, in which a user may notify police if the access is deemed to be unauthorized and thus deemed to be a theft in progress.

A still further object of this invention is to provide a system, as aforesaid, which can store an amount of digital images and can transmit said stored images.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a front view of an automobile dashboard on which a theft identification system is mounted according to the present invention;

FIG. 2 is a rear perspective view of the dashboard on which the system as in FIG. 1 is mounted;

FIG. 3 is a block diagram illustrating the components of the system according to the present invention;

FIG. 4 is a flowchart illustrating the logic of the microcontroller of the present invention.

### DESCRIPTION OF THE PREFERRED EMBODIMENT

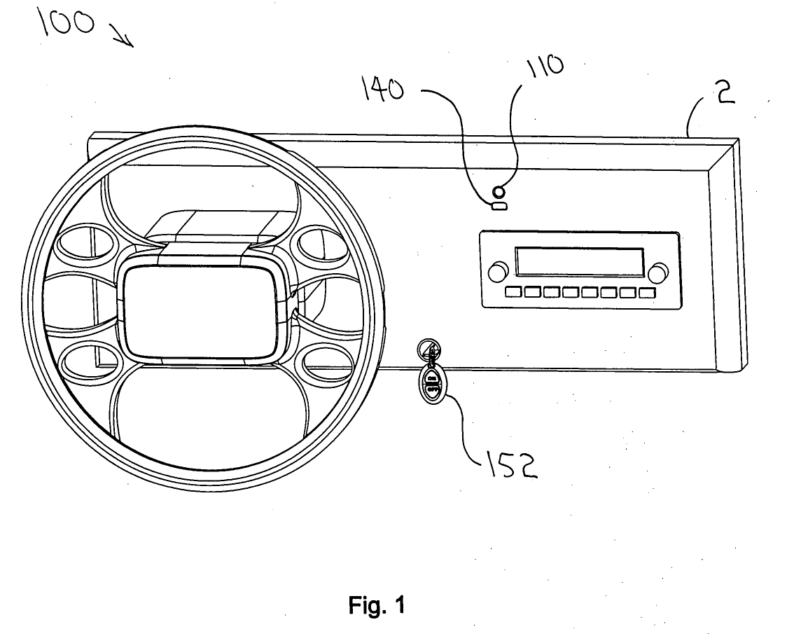

A system according to the present invention will now be described in detail with reference to FIGS. 1 through 4 of the accompanying drawings. More particularly, a theft identification and deterrence system 100 for an automobile (also referred to herein as a security system 100 for an automobile) according to the present invention includes a camera 110, a transmitter 120, and a microcontroller 130 (also referred to herein as a processor 130).

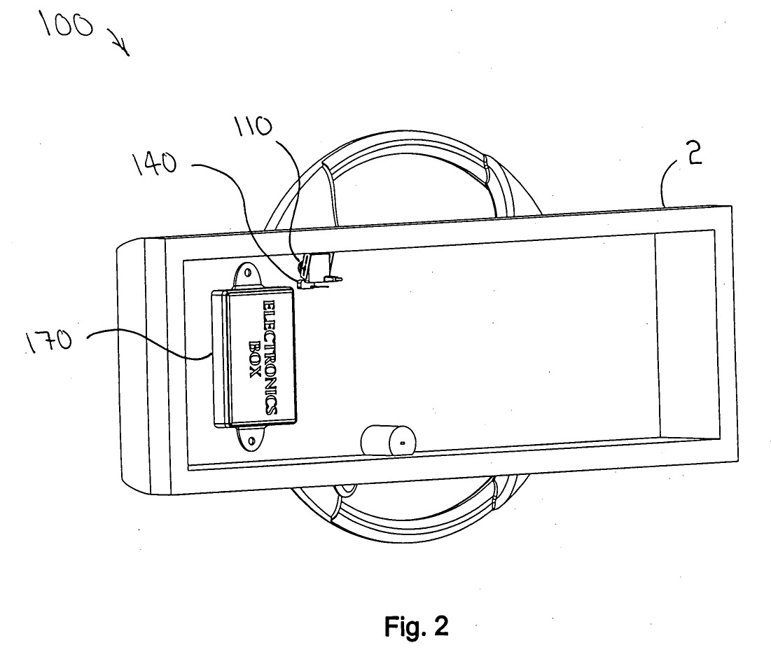

The camera 110 is mounted inside the automobile for capturing images. FIGS. 1 and 2 show the camera 110 mounted in an automobile dash 2, though the camera 110 may be mounted in other places inside the automobile as well, such as on a sun visor, steering wheel, or the like. The camera 110 may capture still images or video images of the automobile interior, and cameras suitable for various lighting conditions may be used. The camera 110 preferably performs well in low light applications, and even more preferably is a day-night camera. Day-night cameras automatically switch to black and white in low light situations and automatically switch to color when the light level is adequate. Most monochrome or black and white cameras have a lower Lux rating than color cameras, and therefore perform better in low light situations.

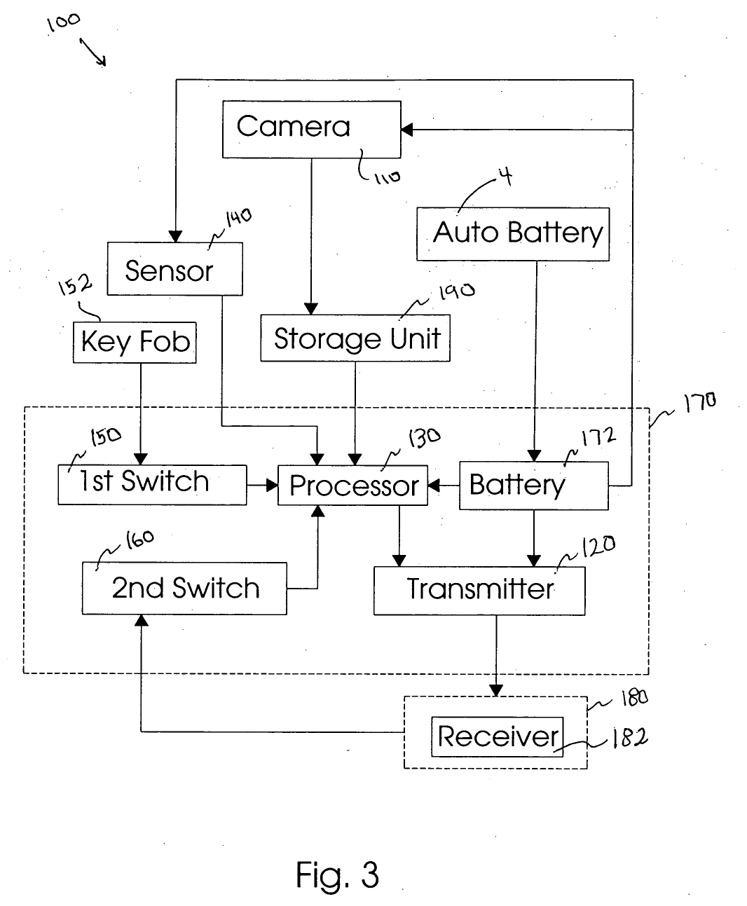

The microcontroller 130 is preferably in electrical communication with the camera 110 and the transmitter 120 for actuating the transmitter 120 to transmit images captured by the camera 110 (FIG. 3). A sensor 140 for sensing a triggering event may also be in electrical communication with the microcontroller 130. As shown in FIGS. 1 and 2, the sensor 140 may be a motion or proximity sensor 140 mounted in the dash 10. Alternately, the sensor 140 may be a pressure sensor 140 mounted in a car seat, a glass-breaking sensor 140 in communication with a car window, or another suitable sensor 140. The triggering event depends upon the type of sensor 140 used. For example, a triggering event for a motion sensor 140 could be the detection of motion; a triggering event for a proximity sensor 140 could be the detection of an object within a predetermined proximity; a triggering event for a pressure sensor 140 mounted in a seat could be the detection of pressure upon the seat; and so forth.

A first switch 150 may be in electrical communication with the microcontroller 130 for selectively activating the microcontroller 130 (FIG. 3). The first switch 150 may be manually operable (such as a button on the automobile dash 2,) or the first switch 150 may be electrically operable upon receipt of a predetermined signal. If the first switch 150 is electrically operable, a key fob 152 that is compatible with the first switch 150 is preferably included for selectively activating the first switch 150.

A second switch 160 may also be in electrical communication with the microcontroller 130 for selectively deactivating the microcontroller 130 (FIG. 3). The second switch 160 is preferably a remotely operable switch 160, such as a switch 160 that may be operated by receiving a signal from the key fob 152, by telephone, through the internet, or by other remote methods. Further, it is possible to combine the first and second switches 150, 160, and such is contemplated herein.

An electronics box 170 (FIG. 2) may house the microcontroller 130, and a battery 172 may be housed in the electronics box 170 as shown in FIG. 3. The battery 172 is preferably connected to the camera 110, the transmitter 120, and the microcontroller 130 so that these elements are powered even if the power supply from the automobile's battery 4 is interrupted. Alternately, the automobile battery 4 may be used to power these elements, or multiple power sources may be used. The battery 172 may be electrically connected to the automobile battery 4 to be selectively recharged.

A viewing unit 180 may be included or may be supplied by a user (FIG. 3). The viewing unit 180 preferably has a viewing unit receiver 182 distinct from the transmitter 120 so that images sent from the transmitter 120 may be received and viewed upon the viewing unit 180. The viewing unit 180 may be a mobile phone, a personal data assistant (PDA), a personal computer, a television, or another suitable device. Specifically, a mobile phone with a color viewing screen is currently preferred.

The system 100 may include a storage unit 190 in electrical communication with the camera 110 for storing a predetermined amount of digital images captured by the camera 110 (FIG. 3). The microcontroller 130 may include programming for actuating the transmitter 120 to transmit the predetermined amount of images captured by the camera 110 and stored in the storage unit 190 when the sensor 140 senses the triggering event (as discussed above). The stored images may provide important information about the time period before the sensor 140 detects the triggering event.

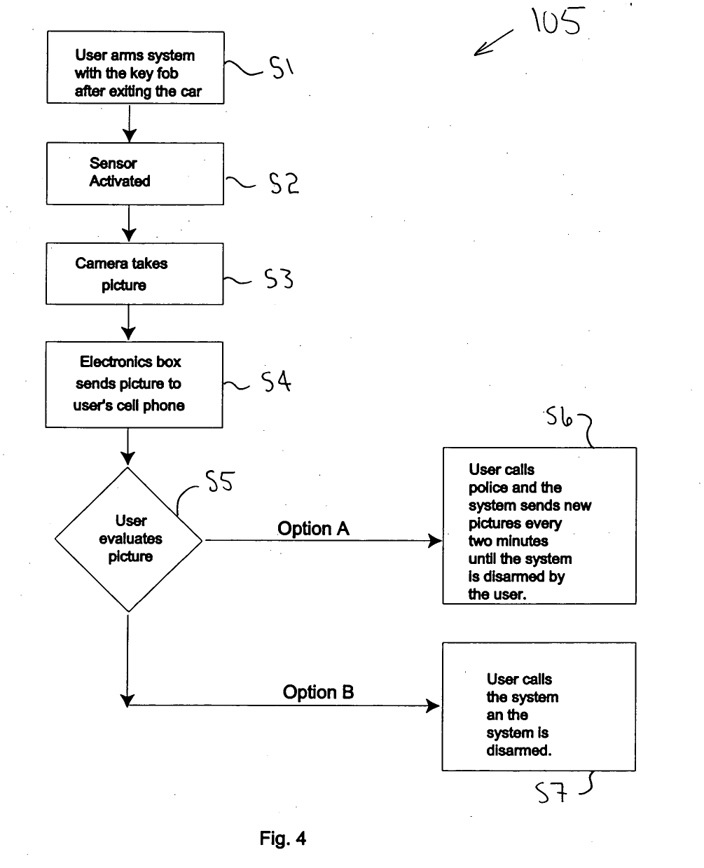

A flowchart depicting a process 105 of the system 100 in use may be found in FIG. 4. At step S1, the user may arm the system 100 by operating the first switch 150 with the key fob 152 to activate the microcontroller 130. The process then continues to step S2.

At step S2, the sensor 140 may detect a triggering event as discussed above. The process then continues to step S3, where the camera 110 may begin capturing images if it was not doing so already. The process then proceeds to step S4.

At step S4, the microcontroller 130 actuates the transmitter 120 to transmit the images captured by the camera 110. The images are then received by the viewing unit receiver 182 so that the user may evaluate the images at step S5. If a theft is occurring, the user proceeds to step S6. If there was a false alarm, the user proceeds to step S7.

At step S6, the user may notify the police and allow the microcontroller 130 to continue transmitting images captured by the camera 110 in order to monitor the situation and identify the perpetrator. Obviously, the stored and transmitted images provide valuable evidence in affecting a later arrest and conviction. It should be appreciated that the images and/or video could also be transmitted directly to a base unit or directly to the police.

At step S7, the user may operate the second switch 160 to deactivate the microcontroller 130. This step most likely corresponds to a situation where the user determines that the person entering the user's vehicle is authorized or where the theft event has been concluded.

According to another embodiment, the microcontroller 130 may include programming for automatically actuating the camera 110 to capture images when the sensor 140 detects the triggering event (as discussed above) and automatically actuating the transmitter 120 to transmit images captured by the camera 110.

It is understood that while certain forms of this invention have been illustrated and described, it is not limited thereto except insofar as such limitations are included in the following claims and allowable functional equivalents thereof.

What is claimed is as follows:

1. A theft identification and deterrence system for an automobile, said system comprising:
a camera mounted inside the automobile for capturing images;
a transmitter; and
a microcontroller in electrical communication with said camera and said transmitter for actuating said transmitter to transmit images captured by said camera.

2. The system as in claim 1, further comprising a sensor in electrical communication with said microcontroller for sensing a triggering event indicative of entry of a person into the automobile.

3. The system as in claim 2, wherein said microcontroller includes programming for:
automatically actuating said camera to capture images when said sensor detects said triggering event; and
automatically actuating said transmitter to transmit images captured by said camera.

4. The system as in claim 1, further comprising a viewing unit having a viewing unit receiver remote from said transmitter.

5. The system as in claim 4, wherein said viewing unit is selected from the group consisting of a mobile phone, a personal data assistant, a personal computer, and a television.

6. The system as in claim 1, further comprising a remotely operable switch in electrical communication with said microcontroller for selectively deactivating said microcontroller.

7. The system as in claim 1, wherein:
said microcontroller is housed in an electronics box mounted in the automobile;
a battery is housed in said electronics box and electrically connected to said microcontroller, said camera, and said transmitter;
the automobile includes an automobile battery; and
said battery is electrically connected to the automobile battery to be selectively recharged.

8. The system as in claim 1, further comprising a switch for activating said microcontroller.

9. The system as in claim 8, wherein said switch is manually operable.

10. The system as in claim 8, wherein said switch is electrically operable.

11. The system as in claim 10, further comprising a key fob compatible with said electrically operable switch for selectively activating said switch.

12. The system as in claim 2, further comprising a storage unit in electrical communication with said camera for storing a predetermined amount of images captured by said camera.

13. The system as in claim 12, wherein said microcontroller includes programming for actuating said transmitter to transmit said predetermined amount of images captured by said camera upon said sensor sensing said triggering event.

14. The system as in claim 1, wherein:
said camera is a day-night camera; and
said sensor is selected from the group comprising a motion sensor, a proximity sensor, a pressure sensor, and a glass breakage sensor.

15. A security system for an automobile, said system comprising:
a camera mounted inside the automobile for capturing images;
a transmitter;
a sensor for sensing a triggering event; and
a processor in electrical communication with said camera, said sensor, and said transmitter, said processor having programming for automatically actuating said camera to capture images when said sensor detects said triggering event and automatically actuating said transmitter to transmit images captured by said camera.

16. The system as in claim 15, further comprising:
a first switch in electrical communication with said processor for selectively activating said processor; and
a second switch in electrical communication with said processor for selectively deactivating said processor;
wherein said second switch is a remotely operable switch.

17. The system as in claim 15, wherein:
said processor is housed in an electronics box mounted in the automobile;
a battery is housed in said electronics box and electrically connected to said processor, said camera, and said transmitter;
the automobile includes an automobile battery; and
said battery is electrically connected to the automobile battery to be selectively recharged.

18. The system as in claim 15, further comprising a storage unit in electrical communication with said camera for storing a predetermined amount of images captured by said camera.

19. The system as in claim 18, wherein said processor includes programming for actuating said transmitter to transmit said predetermined amount of images captured by said camera when said sensor senses said triggering event.

20. The system as in claim 15, wherein:
said camera is a day-night camera; and
said sensor is selected from the group comprising a motion sensor, a proximity sensor, a pressure sensor, and a glass breakage sensor.
